(19) United States
(12) Patent Application Publication
(10) Pub. No.: US 2011/0242749 A1
(43) Pub. Date: Oct. 6, 2011

(54) Electronic Device

(75) Inventors: Chun-Chih Huang, Taipei City (TW); Te-Sen Chin, Taipei City (TW); Jeng-Hong Chen, Taipei City (TW); Po-An Lin, Taipei City (TW)

(73) Assignee: COMPAL ELECTRONICS, INC., Taipei City (TW)

(21) Appl. No.: 12/868,115

(22) Filed: Aug. 25, 2010

(30) Foreign Application Priority Data
Apr. 2, 2010 (TW) 99110413

(51) Int. Cl. G06F 1/16

(52) U.S. Cl. 361/679.08

(57) ABSTRACT

An electronic device is described. The electronic device includes an upper cover and a base. The upper cover includes at least one supporting beam formed in an inner surface thereof and positioned corresponding to at least one boundary of a cavity region of the base. The width of the supporting beam is more than three times of the thickness of the upper cover. In addition, a distance between the edge of the supporting beam and the cavity boundary is less than 10 mm.

### RELATED APPLICATIONS

This application claims priority to Taiwan Application Serial Number 99110413, filed Apr. 2, 2010, which is herein incorporated by reference.

### FIELD OF THE INVENTION

The present invention generally relates to an electronic device. More particularly, the present invention relates to an electronic device with a supporting beam.

### BACKGROUND OF THE INVENTION

In recent years, there has been a lot of progress in optoelectronic and semiconductor techniques. The coming digital era also pushes the rapid development in the LCD market. The LCD's have the advantages of high quality, small volume, light weight, low driving voltage, and low power consumption. Therefore, they are widely used in portable televisions, mobile phones, video cameras, laptop computers, desktop displays, and projective televisions. They have gradually replaced the traditional cathode ray tubes (CRT) and become the mainstream of displays.

Nowadays, the liquid crystal displays become the mainstream of display. However, the size of the liquid crystal display is getting larger, but the thickness of the notebook computer is getting thinner. In the limited space of the notebook computer, the strength of the display panel and the plastic upper cover of the notebook computer cannot be appropriately enhanced.

It is worth noting that the deformation of the plastic upper cover, especially around the keyboard area, can cause the display panel touching the cover of the base of the notebook computer to damage the display panel.

Hence, there is a need to improve the strength of the upper cover of the notebook computer to prevent damage to the display panel.

### SUMMARY OF THE INVENTION

One objective of the present invention is to provide an electronic device having an improved upper cover to effectively improve the strength of the upper cover of the electronic device and effectively prevent damage to the display panel caused by the stress concentration thereon.

To achieve these and other advantages and in accordance with the objective of the present invention, as the embodiment broadly describes herein, the present invention provides an electronic device including a base having a cavity region, a keyboard module disposed in the cavity region, and an upper cover pivoted to the base. The upper cover further includes at least one supporting beam, and the supporting beam is corresponding to at least one boundary of the cavity region when the upper cover is closed on the base.

The width of the supporting beam is preferably larger than three times of the thickness of the upper cover. The supporting beam can further include a main supporting component and two extending components formed on two sides of the main supporting component. The width of the main supporting component is preferably larger than three times of the thickness of the upper cover. In addition, the width of the extending component is preferably larger than a half of the width of the main supporting component. It is worth noting that a distance from an edge of the main supporting component to the cavity boundary is preferably smaller than 10 millimeters.

Furthermore, the supporting beam can be formed by a plurality of supporting components. The total width of the supporting components is preferably larger than three times of the thickness of the upper cover. The distance from an outmost edge of the supporting components to the cavity boundary is preferably smaller than 10 millimeters

At least one reinforced component, e.g. a plurality reinforced ribs perpendicular to the supporting beams, a metal plate or a reinforced sheet metal with covering components for covering the supporting beam, can be formed between the supporting beams. In addition, the base further comprises a base cover adjacent to the cavity region.

Hence, the electronic device according to the present invention can utilize the supporting beam configured above the cavity boundary to enhance the strength of the upper cover and prevent damage to the display panel which is fixed in the upper cover. The supporting beam can further utilize the extending components to further enhance the strength of the upper cover and avoid the sink mark formed on the upper cover. The reinforced component, e.g. a plurality reinforced ribs, a metal plate or a reinforced sheet metal with covering components for covering the supporting beam, can further be formed between the supporting beams to further enhance the strength of the upper cover.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 illustrates a side view of an embodiment of an electronic device according to the present invention;

FIG. 2 illustrates a top view of the embodiment of the electronic device according to the present invention shown in FIG. 1;

FIG. 3 illustrates a side view of another embodiment of an electronic device according to the present invention;

FIG. 4 illustrates an enlarged view of an embodiment of a supporting beam of an electronic device according to the present invention; and

FIG. 5 illustrates an enlarged view of another embodiment of a supporting beam of an electronic device according to the present invention.

### DETAILED DESCRIPTION OF THE PREFERRED EMBODIMENT

The following description is of the best presently contemplated mode of carrying out the present invention. This description is not to be taken in a limiting sense but is made merely for the purpose of describing the general principles of the invention. The scope of the invention should be determined by referencing the appended claims.

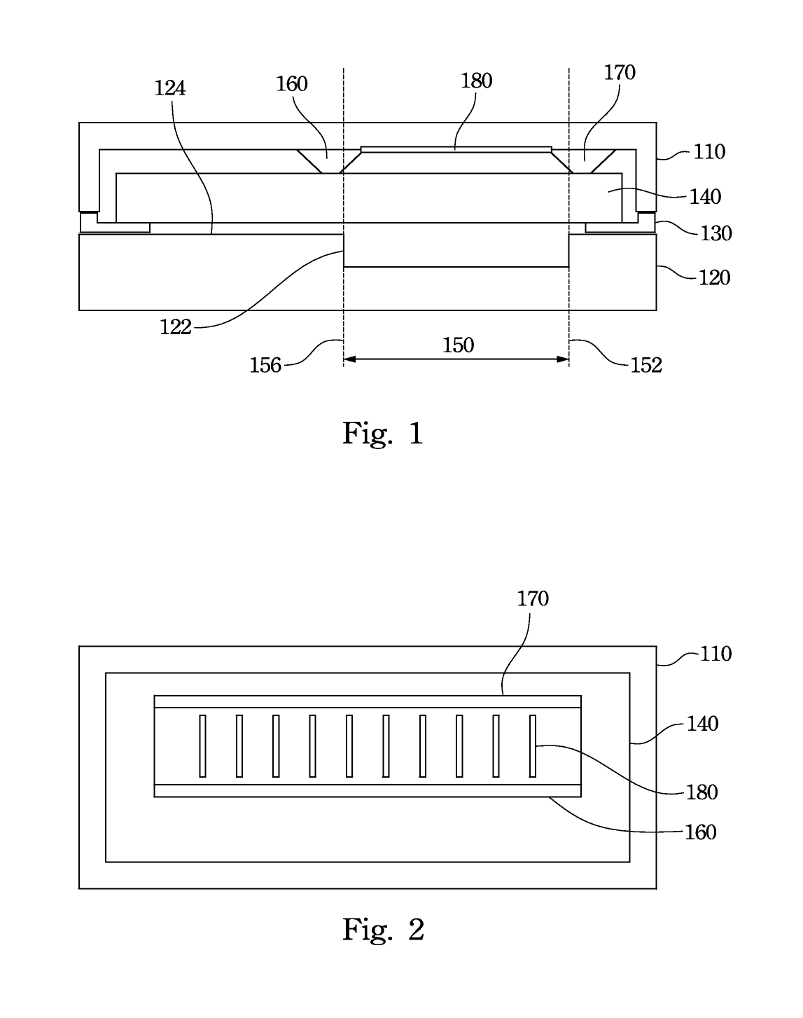

Refer to FIG. 1. FIG. 1 illustrates a side view of an embodiment of an electronic device according to the present invention. The electronic device, e.g. notebook computer, includes an upper cover 110 and a base 120. A display panel 140 is configured between the upper cover 110 and a panel bezel 130. The base 120 includes a base cover 124 and a cavity region 150 to install a keyboard therein. The base cover 124 is adjacent to the cavity region 150. When the upper cover 110 of the electronic device is closed on the base cover 124, the strength of the upper cover 110 and the panel bezel 130 cannot effectively prevent deformation on the display panel 140 because the size of the display panel 140 is getting larger. The display panel 140 may therefore touch a corner 122 of the cavity region 150 in the base 120 to damage the display panel 140 and reduce the life span of the electronic device.

In one embodiment, a supporting beam 160 and a supporting beam 170 are respectively disposed at the cavity boundary 152 and the cavity boundary 156 of the cavity region 150 to enhance the strength of the upper cover 110 and improve the stress on the upper cover 110 so as to prevent deformation on the display panel 140. It is worth noting that the strength of the upper cover 110 is enhanced and the deformation of the upper cover 110 is reduced as the upper cover 110 is subjected to an external force because that the supporting beam 160 and the supporting beam 170 are parallel to the top end and the bottom end of the keyboard.

In addition, at least one reinforced component 180 is disposed thereon to assist the supporting beam 160 and supporting beam 170 so as to further enhance the strength of the upper cover 110. The reinforced component 180 can be made of a metal plate or reinforced components 180, e.g. a plurality of reinforced ribs disposed between and perpendicular to the supporting beam 160 and the supporting beam 170, shown on FIG. 2 to further enhance the strength of the upper cover 110.

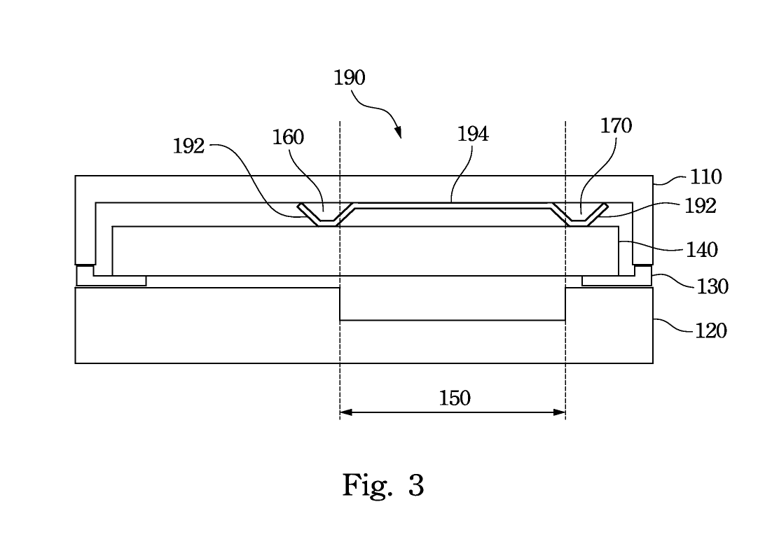

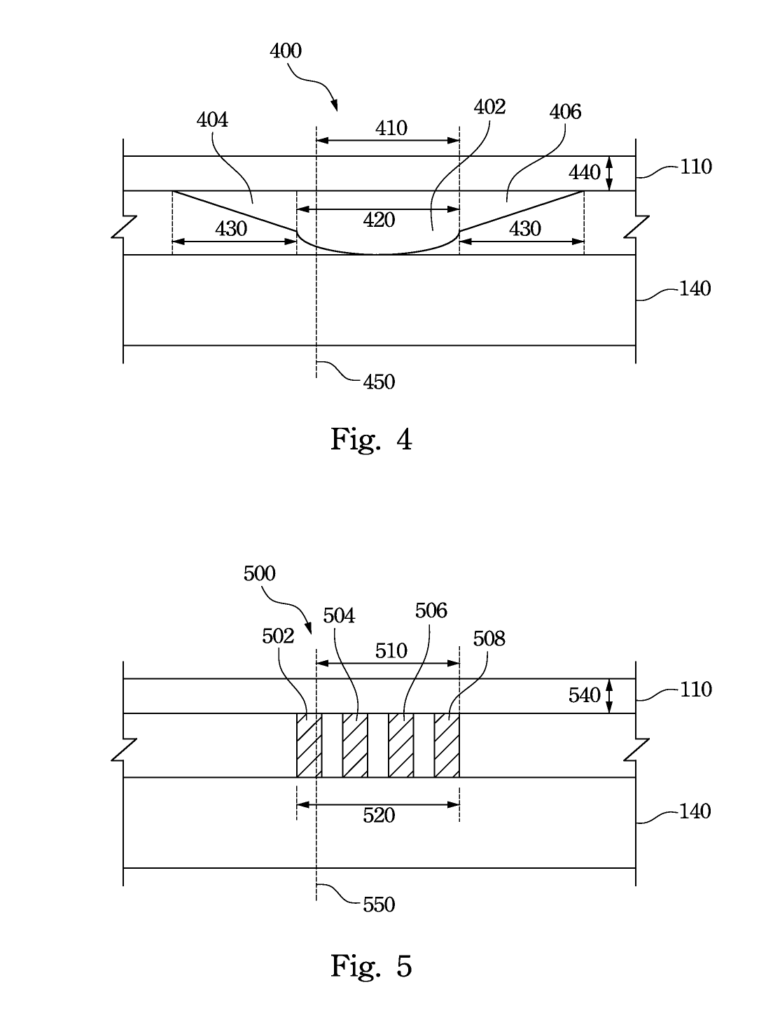

Refer to FIG. 3. The reinforced component can be made of a thinner metal plate to form the reinforced sheet metal 190. The reinforced sheet metal 190 can further include covering components 192 at two end portions thereof to cover the supporting beam 160 and the supporting beam 170, and a connecting component 194 to connect the covering components 192 so as to further increase the strength of the upper cover 110, the supporting beam 160 and the supporting beam 170. Further referring to FIG. 4, an enlarged view of an embodiment of a supporting beam of an electronic device according to the present invention is illustrated. The supporting beam 400 can further include a main supporting component 402 formed beside the cavity boundary 450. The width 420 of the main supporting component 402 is preferably larger than three times of the thickness 440 of the upper cover 110. That is to say, the width 420 of the main supporting component 402 is larger than 3 millimeters as the thickness 440 of the upper cover 110 is 1 millimeter. In addition, a distance 410 from an edge of the main supporting component 402 to the cavity boundary 450 is preferably smaller than two thirds of the width of the main supporting component 402. That is to say, the distance 410 is smaller than 10 millimeters when the total width 420 of main supporting component 402 is about 15 millimeters. Hence, the display panel 140 can effectively prevent from touching the corner of the cavity region and damaging the display panel 140.

In addition, the supporting beam 400 can be further formed an extending component 404 and an extending component 406 on two sides thereof to prevent the sink mark on the upper cover 110, and increase the strength of the upper cover 110. Furthermore, the width 430 of the extending component 404 or the extending component 406 is preferably larger than one-half of the width 420 of the main supporting component 402.

Referring to FIG. 5, an enlarged view of another embodiment of a supporting beam of an electronic device according to the present invention is illustrated. The supporting beam 500 is preferably formed by a plurality of supporting components 502/504/506/508. A distance 510 from the edge of the supporting beam 500, i.e. the outer edge of the supporting component 502 or the outer edge of the supporting component 508, to the cavity boundary 550 is preferably smaller than the two thirds of the width 520 of the supporting beam 500, i.e. the distance 510 is preferably smaller than 10 mm while the width 520 of the supporting beam 500 is about 15 mm, to effectively prevent from damage on the display panel 140 due to touch the corner of the cavity region. In addition, the width 520 of the supporting beam 500, i.e. from the outer edge of the supporting component 502 to the outer edge of the supporting component 508, is preferably larger than three times of the thickness 540 of the upper cover 110.

Hence, the electronic device according to the present application can utilize the supporting beam disposed over and close to the cavity boundary 550 to effectively enhance the strength of the upper cover. When the display panel of the electronic device is fixed on the upper cover, the display panel can effectively prevent from damage. In addition, on the two sides of the supporting beam, the extending components can further increase the strength of the upper cover, and prevent the sink mark formed on the upper cover. The reinforced component can be further formed between the supporting beams to improve the strength of the upper cover. The reinforced component can be the short reinforced ribs formed perpendicular to and between the supporting beams, the metal plate or the reinforced sheet metal with the covering component. The upper cover is effectively improved and the display panel can effectively prevent from damage especially when the upper cover is utilized in a notebook having a width wider than 280 mm, e.g. a notebook computer having a display larger than 15.6 inches. The present invention is illustrated with an upper cover of the display panel but not limited thereto.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. An electronic device, comprising:
a base having a cavity region;
a keyboard module disposed in the cavity region; and
an upper cover pivoted to the base, the upper cover comprising at least one supporting beam, wherein the supporting beam is corresponding to at least one boundary of the cavity region when the upper cover is closed on the base.

2. The electronic device of claim 1, wherein a width of the supporting beam is larger than three times of a thickness of the upper cover.

3. The electronic device of claim 1, wherein the supporting beam further comprises a main supporting component and extending components formed on two sides of the main supporting component.

4. The electronic device of claim 1, wherein the supporting beam comprises a plurality of supporting components formed in the upper cover.

5. The electronic device of claim 1, further comprising a reinforced component.

6. The electronic device of claim 5, wherein the reinforced component is a plurality of reinforced ribs perpendicular to the at least one supporting beam, a metal plate or a reinforced sheet metal with at least one covering component.

7. The electronic device of claim 1, wherein the base further comprises a base cover adjacent to the cavity region.
